(19) United States
(12) Patent Application Publication
(10) Pub. No.: US 2025/0261718 A1
(43) Pub. Date: Aug. 21, 2025

(54) METHOD OF CUSTOM TAILORING APPAREL AT SCALE

(71) Applicant: Meghan Litchfield, San Francisco, CA (US)

(72) Inventor: Meghan Litchfield, San Francisco, CA (US)

(21) Appl. No.: 19/055,673

(22) Filed: Feb. 18, 2025

Related U.S. Application Data
(63) Continuation of application No. 18/597,730, filed on Mar. 6, 2024, now abandoned.
Application No. 18/597,730 is a continuation of application No. 18/130,739, filed on Apr. 4, 2023, now abandoned.
Application No. 18/130,739 is a continuation of application No. 17/366,981, filed on Jul. 2, 2021, now abandoned.

(51) Int. Cl. A41H 43/00; A41D 1/02; A41D 1/04; A41D 1/06; A41D 27/00; A41H 1/02; A41H 31/00; G06Q 30/0601

(52) U.S. Cl. CPC A41H 43/00; A41D 27/00; A41H 1/02; A41H 31/00; G06Q 30/0621; A41D 1/02; A41D 1/04; A41D 1/06

(57) ABSTRACT

A method of creating custom garments at scale comprising utilization of a multitude of numerical customer measurement inputs and non-numerical customer fit style inputs to generate finished garment measurements. A multitude of fit block and sized versions of the garment are mass-manufactured, and then a matching and selecting process is applied to select a fit block and sized version of the garment after comparison of the finished garment measurements with the fit block and size measurements. Variances between the measurements are used to guide matching to a particular fit block and size as well as to generate alteration outputs and instructions for tailoring the fit block and sized garment into a custom garment altered to the individual customer's measurements and inputs.

### CROSS-REFERENCE TO RELATED APPLICATION

This application is a continuation of U.S. Ser. No. 18/597,730 filed on Mar. 6, 2024 entitled “Method of Custom Tailoring Apparel At Scale.” U.S. Ser. No. 18/597,730 is a continuation of U.S. Ser. No. 18/130,739 filed on Apr. 4, 2023 entitled “Method of Custom Tailoring Apparel At Scale.” U.S. Ser. No. 18/130,739 is a continuation of U.S. Ser. No. 17/366,981 filed on Jul. 2, 2021 entitled “Method of Custom Tailoring Apparel at Scale.” U.S. Ser. No. 17/366,981 is a continuation of U.S. Ser. No. 15/983,952 filed on May 18, 2018 entitled “Method of Custom Tailoring Apparel at Scale.” Each of the foregoing are incorporated herein by reference as part of the disclosure of this application.

### TECHNICAL FIELD

The present disclosure relates generally to the field of apparel, and more particularly to producing custom tailored apparel. More particularly, exemplary embodiments comprise systems, methods, processes and algorithms for creating, manufacturing, and delivering tailored apparel at scale and without the customer present in-person.

### BACKGROUND

While people exist in significantly varying shapes and sizes relative to each other, the apparel industry has long sold clothing designed and created to fit a so-called “average” person or a generic fitment pattern (sometimes referred to as a basic block), and manipulated the apparel dimensions as a whole up or down for various sizing that may or may not fit actual consumers, each of whom must select from one of only a few sizes in an attempt to find a finished garment that “fits” that individual consumer.

In contrast, custom-tailoring of clothing has traditionally occurred in the apparel industry at a much greater cost, both monetary and time. Such custom-tailoring involved a customer visiting a physical store to have a variety of measurements taken, from which tailors would then create bespoke garments to fit those measurements for an individual by starting with raw apparel materials and building up a garment from those materials to a single finished product each time, with finished product being delivered to a customer sometimes weeks later. Alternatively, a tailor could also employ the made-to-measure tailoring method, by taking an off-the-rack garment in a traditional size, and pinning and tailoring it to the individual body. Both bespoke and made-to-measure methods of tailoring require the person to be present, and are done as one-off creations in small quantities. Accordingly, improved systems and methods for custom tailoring of apparel remain desirable.

### SUMMARY

In an exemplary embodiment, custom tailored apparel is designed, manufactured, and delivered directly to a customer such that the apparel is custom tailored to that particular customer's body shape and measurements without the customer present. A customer interacts with an internet or intranet web site (or other electronic interaction portal, such as an application on a cellular phone) to provide pertinent fitting measurements and select options relating to the item, style, color, and other aesthetic and/or functional aspects of a garment, and provide inputs as to how they prefer the garment to fit. Custom measurements of the customer are provided, preferably generated via software such as a phone application and that phone's camera scanning the customer's pertinent body areas, or taking photographs of the customer and generating pertinent measurements via means such as photogrammetry, which are then transmitted to the apparel designer and/or manufacturer or other parties responsible for the manufacture of a desired finished garment.

The general garment for sale is mass-produced in a partially unfinished manner comprising a multitude of fit blocks and sizes and each individual garment is later custom tailored to finish the garment specific to the calculated final garment measurements for the individual customer. Algorithms and processes utilize mathematical formulas in conjunction with the customer's measurements and fit style selections to generate final garment measurements and then match them to one of the multitude of fit blocks and sizes that most closely aligns with the customer's measurements, and then custom tailoring adjustments are mathematically determined for how to precisely tailor the partially finished garment to match the customer's measurements. Thereby, the customer's specific measurements are mapped to the most appropriately sized fit block garment and the fit block and size garment is tailored to the actual measurements of that particular customer to achieve the desired final customized garment.

Exemplary embodiments utilize inputs of individual customer garment customizations and selections (such as length, fit, fit style considerations, and other aesthetic or functional options and selections), along with an individual customer's body measurements, to take what would otherwise be the corresponding final garment measurements and adjust such measurements to take into account non-mathematical fit style considerations. The disclosed method generates outputs specific to an individual customer's garment, such as final garment measurements and a fit block and size assignment/match and individual custom mathematical adjustments and finishing, that enable custom tailoring and finishing of an individual garment specific to an individual customer. Exercising the algorithms and processes allows for timely custom tailoring of garments at scale more quickly than the custom tailoring process referenced in the Background above. Within preferably days of a garment being ordered by a remote customer, a custom-tailored finished version of the garment is delivered directly to the customer. The customer never needs to be present or visit a physical location to manufacture the custom tailored garment.

### BRIEF DESCRIPTIONS OF DRAWINGS

FIG. 1 is a high-level flow diagram used to summarize the systems, methods, processes, and algorithms of preferred embodiments.

### DESCRIPTION OF THE PREFERRED EMBODIMENTS

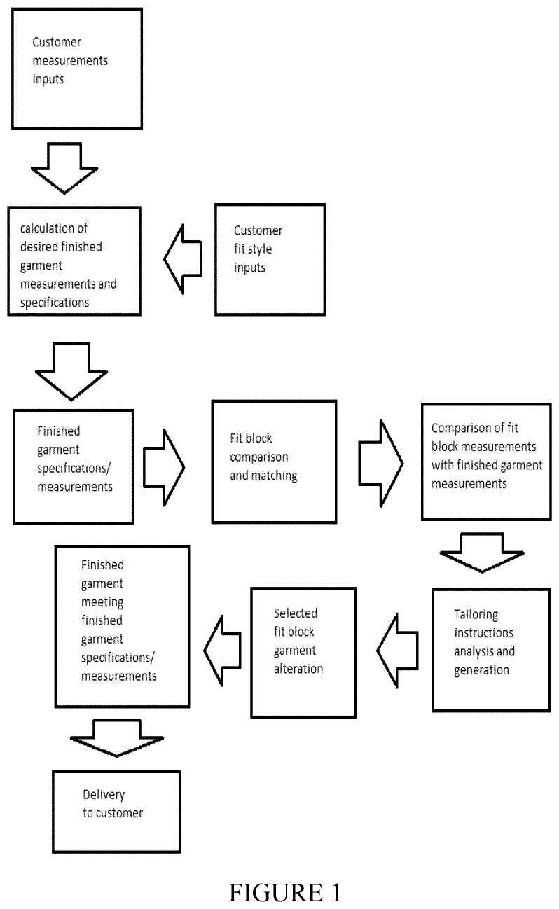

With reference to FIG. 1 and all disclosures of this application (including those above and below and any incorporated by reference), exemplary embodiments comprise systems, methods, processes and algorithms for designing, creating, manufacturing, and delivering custom tailored apparel to remote customers, at scale. The description from the Summary section above is expanded on below and includes a discussion of preferred embodiments. The nature and scope of exemplary embodiments is not limited to only one or a few types of garments, but rather can be adapted and applied to virtually any type of garment while remaining within the scope of the invention. It is contemplated that much or all of the systems, methods, processes and algorithms described are preferentially implemented and performed with hardware that includes the use of computers and may include interconnected and communicating computers and devices containing computing processors.

Initially, a customer seeking apparel provides certain types of inputs desired for the creation of the custom fitted garment, preferably via a computerized interface adapted to receive inputs from the customer. The interface may be via an internet web page or other electronic interaction portal, such as an application on a cellular phone. The nature and scope of the inputs varies depending on the particular garment being purchased by the customer, as information pertinent to fit, aesthetic, and function varies among garment types and varies as to what is offered by different garment providers.

Inputs provided by the customer may comprise, and may be specific to, the customer's measurements of specific aspects of the body. Such measurements may comprise, for example, chest, natural waist, hip, sleeve length, torso length, full hip, neck width, shoulder width, thigh, calf, and leg inseam. The types of input measurements will vary depending on the type of garment sought and what information is needed to manufacture a particular garment having characteristics sized to a customer's personal measurements, as features of one type of garment (such as sleeve length for a sweater) are not needed for certain other types of garments (such as pants). The following measurements comprise inputs in preferred embodiments for particular garments, for example:
Sweater: chest, natural waist, hip, sleeve length, torso length.
Jacket: chest, natural waist, full hip, sleeve length from center back, torso length from high point shoulder to natural waist, neck width, shoulder width.
Tee shirt: Chest, natural waist, full hip, sleeve length from center back, torso length from high point shoulder to natural waist, shoulder width.
Wide leg pant: Natural waist, full hip, thigh, leg inseam.
Ankle pant: Natural waist, full hip, thigh, calf, leg inseam.

Such customer measurements inputs may be provided from information already in the customer's possession (such as if the customer has been manually measured by another person) or information generated by other sources (such as a body scanner, or body scanning or photogrammetry software in conjunction with a camera and/or photographs). Preferably, such measurements are generated via a software application on a smartphone in which the application utilizes the smartphone's camera to capture photos of the customer and calculates various measurements from the photos based on an input, such as the customer's height. Input of at least one measurement, such as height of the customer, may be needed by such software to generate a relative scale from which to calculate the other desired measurements. The customer's measurements are transmitted to the provider of the apparel or manufacturer or other parties involved in the creation of the apparel for use in creating and tailoring the desired garment(s), and optionally stored for future repeat use.

Other inputs provided by the customer may be specific to the customer's desired fit style aspects of the garment. Such fit style aspects are preferably characteristics of how the garment fits in one or more areas of the customer's body, how the garment conforms relative to the customer's shape, and other aspects of the fit of the garment such as the length (full versus short, for example), the overall fit in terms of the body type (standard versus slim, for example), torso length (long versus short, for example), sleeve length (short versus medium versus long, for example), and leg length (full with heel versus full with sneaker versus ankle, for example, or cropped versus ankle above bone versus ankle bottom of bone, as another example). Such fit style aspects are preferably determined by the producer of the garment, although it is contemplated that a free form field could be provided for a free input of the customer's choosing. Other such aspects of the requested fit style as may be pertinent depend on the particular garment at issue and what inputs are necessary to provide sufficient information regarding the customer's preferences and selections. Any particular garment will have a number of combinations of the various fit style aspect inputs, depending on the number of fit style aspects inputs required. For example, if there are only 2 fit style aspects required, and each has 2 optional selections, there would be 4 possible combinations of the fit style aspect inputs.

Other inputs provided by the customer may be specific to the desired aesthetic appearance or function of the garment. Such inputs may be, for example, colors, presence of and/or number of pockets, material selections, and other such variations or options available for the desired garment.

The general basic garment desired by the customer is mass-produced in a multitude of fit blocks and sizes (referred to as fit block versions) prior to each individual garment undergoing tailoring to meet specific individuals' inputs and becoming a custom tailored garment. Each fit block and size is a partially unfinished version of the garment with predetermined garment measurements or specifications specific to each fit block and size, but the measurements vary according to sizing among the fit blocks (for example, an extra-small fit block A would have smaller measurements as compared to a medium fit block A). The partially unfinished aspects of the garment may vary in accordance with the aims and practice of the disclosure to allow the disclosed custom tailoring to occur, but for example, if pants are the garment being purchased then the inseam hems and ankle hems and waist band are preferably unfinished. The predetermined garment measurements or specifications of each fit block and size preferably comprise the same categories as the customer's measurement inputs described above. The measurements of the multitude of fit blocks and sizes for any particular garment are preferably derived from data collected from a pool of persons that identify or are identified as potential customers of the garments or apparel being designed and manufactured. A sampling of some or all of such data can be analyzed to look for averages, trends, anomalies, and other pertinent statistical results that are then used to guide the creation of the fit blocks and sizes. Preferably, the fit block and sizing specifications are based on the measurements of an average or median model from such data to yield sizing for one fit block, with scaling and modifications in the sizing up or down to create additional fit blocks and sizes. The fit block and numerically sized versions of the garment are partially unfinished such that each individual production of the garment can be later custom tailored to finish the individual garment specifically to meet the measurements and fit style choices of the individual customer, with the final garment specifications resulting from such inputs and thus yielding a custom tailored garment for that customer in an expedited and less costly manner as compared to traditional custom tailoring. The final custom-tailored garment is a one-of-a-kind specification for the individual customer.

The inputs described above are then utilized in mathematical formulas specific to each garment to generate final garment measurements or specifications that take into account the inputs of the customer. The final garment specifications are measurements that the final garment must closely meet (and most preferably nearly exactly meet when possible within the concepts of the systems and processes and algorithms described and the practicalities and limits of apparel tailoring customs and techniques) to conform to the inputs of the customer and yield the desired custom tailored garment. The final garment measurements preferably comprise the same categories as the predetermined garment measurements or specifications of each fit block, which are also preferably the same categories as the customer's measurement inputs, as previously noted, with mathematical modifications that account for the various fit style aspect inputs. The non-mathematical fit style inputs are used to make mathematical adjustments in the process of translating the customer measurement inputs into finished garment measurements via inclusion of a mathematical constant or hard number in the calculation or formula for the final garment measurements (such as adding or subtracting the number as part of the formula) wherein the constant or hard number is determined based on the selections by the customer of the non-numerical customer fit style inputs and may also be relative to the numerical customer measurement inputs. As an example, if a fit style input from a customer is that the customer wants a shorter sleeve length, then the sleeve length for the final garment measurements must be reduced from what it would otherwise have been. Other examples could include a customer's fit style input of desiring a slim fit of sweater, or a longer torso length in a sweater, and making corresponding mathematical changes to the calculations for the finished garment measurements to account for such non-mathematical fit style inputs from the customer.

The calculated final garment measurements are compared with and mapped to the multitude of fit blocks and sizes, which have unaltered garment measurements associated with each of them, seeking and selecting the fit block and size that most closely matches the desired final garment specifications, subject to certain rules in the matching process. One aspect of the matching and selecting process seeks to achieve the lowest sum of variances when comparing the final garment measurements with the measurements of each fit block, subject to other rules, limitations, and guides in the process. The process considers the variances among all of the final garment measurements, but in some circumstances a number of those measurements may be elevated above the other measurements in importance to the matching process to enable the preferred subsequent tailoring considerations. For example, with upper torso garments such as sweaters, the chest measurement may be given the described elevated importance in the matching process. Additionally, the matching and selecting process must take into account that in most cases one or more measured aspects of the fit block and sized version of a garment cannot be altered in the later tailoring steps, and thus deference in the process to such aspects is required and elevated above other steps in the process. For example, if the garment is a jacket, the chest, neck, and shoulders of the fit block version of the jacket cannot be changed, and thus adherence to low variances in such measurements is more important than adherence to low variances in other measurements when selecting the best fit block version. The type of garment will dictate which measured aspects of a fit block version cannot be altered in the later tailoring steps.

During the matching and selecting process, only minimal variances (for example, at a maximum limit of ¼ inch) are preferably allowed in exceeding the fit block and size specifications (an exceeding variance) when comparing the final garment measurements with the fit block and size's measurements, as exceeding a fit block and size's measurement beyond such a minimal variance goes beyond the allowable proper fit margins for a garment, and could in some circumstances in the subsequent custom tailoring require the addition of fabric to a fit block standard garment, which is undesirable for a number of reasons, both aesthetic and practical. In contrast, a variance wherein the final garment measurement is less than a fit block and size's measurement (an under variance) requires the removal of fabric from a standard garment as part of the custom tailoring process, which may be accomplished without affecting the final fit of the final garment and thus is the preferred nature of any necessary alterations. But when only a very minimal exceeding variance occurs (within the ¼ inch limit), the difference in the measurements of the final custom tailored garment is within the allowable proper fit margins of the garment and negligibly affects the fit of the garment and does not cause a significant deviation from the desired final garment measurements. It is also preferred that under variances not exceed ¼ inch when possible, however that preference is preferably subordinate to complying with the limit on exceeding variances.

Once the appropriate fit block and size is selected via the matching and selecting process, the final garment measurements are compared with the chosen fit block and size measurements to achieve mathematical outputs for alterations to be made to the fit block and sized version of the garment to yield a final garment having the final garment measurements. The alteration outputs are calculated with respect to each of the final garment measurements such that an alteration output is determined for each such measurement of the fit block and sized version and the final garment. Alteration outputs dictate the alteration instructions necessary to modify the fit block and size version of the garment such that it meets the final garment measurements, such as an instruction to reduce the standard fit block and size garment in one or more measurement respects (such as taking in the waist of pants) or an instruction that no alteration is necessary. In generating the alteration instructions, some alteration outputs may be determined to be small enough relative to the final garment measurements that the alteration outputs are deemed negligible and the corresponding alteration instructions thus considered to qualify as “no alteration” instructions.

Following the alteration instructions, an individual garment is then tailored from a fit block and sized garment to create a final customized garment meeting the inputs from a particular customer. Within days of a garment being ordered by a customer, a custom-tailored finished version of that garment is delivered directly to the customer as a result of application of principles contained in the present disclosure. At no time does the customer need to visit a store, or meet the tailor in-person, for various exemplary embodiments to be successful.

Whereas the disclosures set forth preferred embodiments, it should be apparent to those skilled in the art that various changes may be made in the form of the exemplary embodiments without affecting the scope thereof. The disclosures are not intended in any way to limit the broad features or principles of the present disclosure, or the scope of the claims. Any references to specific numerical values are only examples of the preferred disclosure without limitation of the scope of the present disclosure or the claims.

What is claimed:

1. A method of creating a garment for a customer, comprising the steps of:
a. receiving one or more numerical customer body measurements inputs;
b. receiving one or more non-numerical customer fit style inputs, wherein said fit style inputs comprise at least one fit style considerations specific to an aesthetic or function of said garment;
c. calculating numerical finished garment measurements as an output from said numerical customer body measurements inputs and said non-numerical customer fit style inputs;
d. creating a plurality of fit block versions of said garment, in which each fit block version has a set of fit block measurements particular to that fit block version as compared with the other fit block versions;
e. comparing said finished garment measurements with said sets of fit block measurements;
f. calculating variances between said finished garment measurements and said sets of fit block measurements;
g. determining from said step of calculating variances whether there is no variance, an exceeding variance, or a reduction variance;
h. selecting one of said fit block versions as a best match to said finished garment measurements;
i. subtracting said fit block measurements for said selected fit block version from said finished garment measurements to create alteration outputs;
j. translating said alteration outputs to alteration instructions; and
k. tailoring said fit block version according to said alteration instructions.

2. The method of claim 1, further comprising the step of dictating fields for said one or more numerical customer body measurement inputs.

3. The method of claim 1, further comprising the step of dictating fields for said one or more non-numerical customer fit style inputs.

4. The method of claim 1, wherein said one or more non-numerical customer fit style inputs effect a mathematical adjustment in said step of calculating numerical finished garment measurements.

5. The method of claim 1, wherein said steps of receiving, calculating, comparing, calculating, determining, selecting, subtracting and translating are performed by computer processors adapted to execute formulas and algorithms for said steps.

6. The method of claim 1, wherein said selecting step further comprises complying with one or more prioritized variance limits.

7. The method of claim 6, wherein said one or more prioritized variance limits is a limit as to one or more of said finished garment measurements exceeding one or more of said fit block measurements.

8. The method of claim 1, wherein said step of calculating variances is performed by subtracting said finished garment measurements from one or more of said fit block measurements that correspond to said one or more fit block versions.

9. The method of claim 1, wherein said step of selecting further comprises prioritizing the minimization of one or more variances resulting from said step of calculating variances above minimization of the other one or more variances.

10. The method of claim 1, wherein said step of selecting further comprises setting one or more limits for said one or more variances.

11. The method of claim 1, further comprising the step of using value ranges for said alteration outputs that determine said alteration instructions.

12. The method of claim 11, wherein select value ranges for said alteration outputs are identified to be ignored and yield a differing alteration instruction than otherwise would result in said step of translating.

13. The method of claim 12, wherein said value ranges are specific to and depend from the value of one or more of said numerical finished garment measurements.

14. The method of claim 1, wherein said step of calculating numerical finished garment measurements further comprises using one or more mathematical constants as a factor affecting the calculating step outcome, and wherein said constant is selected based on which of one or more of said non-numerical customer fit style inputs is received.

15. The method of claim 1, wherein said step of selecting comprises prioritizing the lowest sum of said variances from said calculating step and identifying the fit block version with which the lowest sum of said variances is associated.

16. The method of claim 1, wherein said step of calculating numerical finished garment measurements further comprises transforming said one or more non-numerical customer fit style inputs into one or more numerical constants relative to a desired effect on said step of calculating numerical finished garment measurements.

17. A finished garment created by the process comprising the steps of:
a. creating a plurality of fit block versions of said finished garment, in which each fit block version has a set of fit block measurements particular to that fit block version as compared with the other fit block versions;
b. comparing said finished garment measurements with said sets of fit block measurements to assess whether variances exist between said sets of compared measurements;
c. calculating numerical values for variances between said finished garment measurements and said sets of fit block measurements;
d. selecting one of said fit block versions as a best match to said finished garment measurements based on said step of calculating, wherein one or more fit block versions are considered; and
e. tailoring said selected fit block version to substantially conform to said finished garment measurements.

18. The finished garment of claim 17, wherein said selecting step comprises prioritizing the minimization of one or more of said variances resulting from said step of calculating variances above minimization of the other one or more of said variances, identifying each of said fit block measurements as either an alterable or unalterable measurement, and setting one or more limits within the selecting step based on all of said unalterable measurements wherein said limits define which of said fit block versions may be considered.

19. The finished garment of claim 18, wherein said selecting step further comprises identifying the fit block version with which the lowest sum of variances among said alterable measurements is associated.

20. A finished garment created by a method comprising the steps of:
a. receiving one or more numerical body measurements of a customer intending to purchase and wear said finished garment;
b. receiving one or more non-numerical fit style inputs specific to said customer, wherein said fit style inputs are directed to an aesthetic or a function of said finished garment;
c. generating a tabulation of numerical finished garment measurements from said numerical customer body measurements inputs and said non-numerical customer fit style inputs;
d. manufacturing one or more physical versions of a plurality of fit block versions of said garment from one or more fabrics, in which each fit block version conforms to a set of fit block measurements particular to that fit block version as compared with the other fit block versions;
e. comparing said tabulation of numerical finished garment measurements with said sets of fit block measurements, and tabulating variances between said numerical finished garment measurements and said sets of fit block measurements;
f. determining from said step of tabulating variances whether there is no variance, an exceeding variance, or a reduction variance;
g. selecting one of said fit block versions as a best match to said finished garment measurements;
h. subtracting said fit block measurements for said selected fit block version from said finished garment measurements to create alteration outputs;
i. translating said alteration outputs to documented alteration instructions; and
j. physically altering the fabric of said fit block version in accordance with said documented alteration instructions such that the fabric of said fit block version conforms to said finished garment measurements.
